(19) United States
(12) Patent Application Publication
(10) Pub. No.: US 2025/0339883 A1
(43) Pub. Date: Nov. 6, 2025

(54) Method for cleaning a coupling unit for coupling a component to an article and related machine for coupling

(71) Applicant: G.D S.p.A, Bologna (BO) (IT)

(72) Inventors: Andrea BIONDI, Bologna (BO) (IT); Antonio VITALI, Bologna (BO) (IT); Umberto ZANETTI, Bologna (BO) (IT); Lorenzo FILOSA, Bologna (BO) (IT); Ivan PIOL, Bologna (BO) (IT); Ivan PIOL, Bologna (BO) (IT)

(21) Appl. No.: 19/045,049

(22) Filed: Feb. 4, 2025

(30) Foreign Application Priority Data
Feb. 5, 2024 (IT) 102024000002373

(51) Int. Cl. B08B 5/04; B08B 5/02; B08B 15/02; B65B 29/02

(52) U.S. Cl. CPC B08B 5/04; B08B 5/02; B08B 15/02; B65B 29/022; B08B 2215/003; B65B 2210/06

(57) ABSTRACT

A method for cleaning a coupling unit for coupling a component to an article and a machine for coupling the component to the article including the coupling unit and a cleaning system of the coupling unit. The coupling unit includes a housing body having at least one seat shaped for accommodating the article, a coupling device for retaining the component, the cleaning system has a suction head and an emission mouth for emitting pressurized air connected to a compressed air circuit, and the method includes, with the housing body in a first configuration in which the housing body and the coupling device are mutually spaced apart, realizing a reciprocal operational configuration between the cleaning system and the coupling unit in which the suction head and the emission mouth are in mutual proximity with the housing body and at an inlet of the seat, activating the suction head, activating the emission mouth.

### TECHNICAL FIELD OF INVENTION

The present invention relates to a method for cleaning a coupling unit of a component to an article, and a relative machine for coupling comprising the coupling unit and a cleaning system of the coupling unit.

The present invention finds a preferred application in the field of capsule production for infusion products, in particular beverages obtained through an infusion process and with the addition of an edible liquid such as water or milk to obtain an infusion, for example coffee, a field to which reference will be made hereinafter without loss of generality.

### STATE OF THE ART

In the aforementioned field of capsule production, machines for the production of capsules containing coffee are known. In particular, it is known to couple a lid to a capsule body, once filled with coffee powder, to obtain the sealed capsule.

### SUMMARY OF THE INVENTION

With the terms “perpendicular” and “orthogonal,” it is meant a substantial perpendicularity and orthogonality between two elements, comprising both the ideal case in which said elements are arranged with respect to each other to form a right angle and more frequent cases in which the two elements are arranged with respect to each other to form an angle deviating from the right angle (e.g., included in a range of ±15°, more preferably ±10°, with respect to the right angle) but still in a negligible or non-relevant manner for the functioning of the present solution. Similarly, the term “parallel” and similar terms refer to a condition of pure parallelism or to a parallelism included in the range 0°±15°, more preferably ±10°.

The Applicant has observed that, in the field of infusion capsule production, the coupling units of the lid to the capsule body filled with coffee operate in an environment with a high degree of contamination due to the presence of coffee powder released into the air. For example, the coffee powder may be released from the capsule bodies (before the coupling of the lid) as a result of the movements (typically rotational motion) of the coupling unit and/or from the devices for dispensing the coffee powder into the capsule body.

For example, with reference to the coupling unit described in document WO2022029546A1, the Applicant has found that the aforementioned contamination, in addition to involving the entire coupling unit and the entire coupling machine in which the unit itself is housed, particularly involves the housing body of the coupling unit, that is, the body provided with one or more housing seats for housing respective capsule bodies after filling with the coffee powder in preparation for the coupling with the lid.

In particular, the Applicant has observed that the coffee powder present in the air re-deposits in correspondence with the opening of the housing seat of the housing body and, in general, on the face of the housing body that contains said opening of the seat, said face being typically arranged horizontally.

In this situation, the Applicant has found that said re-deposition of coffee powder in correspondence with the opening of the seat causes significant problems in terms of operation of the coupling unit. In fact, it is precisely in correspondence with said opening that the sealing of the controlled-atmosphere environment is achieved, which is formed by the union of the housing body with the coupling device (which holds the lid) and within which the actual coupling between the capsule body and the lid takes place. In other words, the deposited coffee powder hinders, up to preventing, the desired sealing of the controlled-atmosphere environment, resulting in problems in the production process (e.g., impossibility of creating the controlled-atmosphere environment).

The Applicant has therefore addressed the problem of cleaning a coupling unit of a component to an article, in particular the surfaces located in correspondence with the opening of the housing seat in which the article is housed, in an effective, rapid, and/or economical manner, limiting the overall machine downtime and/or the use of labor and/or the related costs.

According to the Applicant, the aforementioned problem is solved by a method for cleaning a coupling unit, and by a machine for coupling, in accordance with the attached claims and/or according to the following aspects and embodiments.

According to one aspect, the present invention relates to a method for cleaning a coupling unit for coupling a component to an article.

Preferably said method comprises providing said coupling unit.

Preferably said coupling unit comprises a housing body comprising at least one seat shaped for accommodating said article.

Preferably said coupling unit comprises a coupling device configured for retaining said component.

Preferably said coupling comprises a handling system.

Preferably a handling system configured for reciprocally moving said housing body and said coupling device between a first configuration, in which said housing body and said coupling device are mutually spaced apart, and a second configuration, in which said housing body and said coupling device are positioned closely to each other for allowing a coupling between said component and said article.

Preferably said method comprises providing a cleaning system.

Preferably said cleaning system comprises a suction head.

Preferably said cleaning system comprises at least one emission mouth for emitting

pressurized air connected to a compressed air circuit.

Preferably said method comprises, with said housing body in said first configuration, realizing a reciprocal operational configuration between said cleaning system and said coupling unit in which said suction head and said at least one emission mouth are in mutual proximity with said housing body and at an inlet of said seat.

Preferably said method comprises activating said suction head.

Preferably said method comprises activating said at least one emission mouth.

According to another aspect, the present invention relates to a machine for coupling a component to an article.

Preferably said machine comprises at least one coupling unit.

Preferably said coupling unit comprises a housing body comprising at least one seat shaped for accommodating said article.

Preferably said coupling unit comprises a coupling device configured for retaining said component.

Preferably said coupling unit comprises a handling system.

Preferably said handling system is configured for reciprocally moving said housing body and said coupling device between a first configuration, in which said housing body and said coupling device are mutually spaced apart, and a second configuration, in which said housing body and said coupling device are positioned closely to each other for allowing a coupling between said component and said article.

Preferably said machine comprises a cleaning system.

Preferably said cleaning system comprises a suction head.

Preferably said cleaning system comprises at least one emission mouth for emitting pressurized air connected to a compressed air circuit.

Preferably said machine comprises a driving system connected to at least one among said coupling unit and said cleaning system and configured for realizing, with said housing body in said first configuration, a reciprocal operational configuration between said cleaning system and said coupling unit in which said suction head and said at least one emission mouth are in mutual proximity with said housing body and at an inlet of said seat.

According to the Applicant, achieving the aforementioned reciprocal operational configuration when the housing body is in the first configuration, that is, when it is spaced from the coupling device, allows for sufficient free space to bring the cleaning system closer to the opening of the housing seat of the article in order to achieve the desired cleaning effectiveness.

Moreover, the combined presence of the emission nozzle and the suction head allows both to lift the coffee powder from the surfaces by means of the compressed air jet and to suction the lifted powder and/or the powder still on the surface by means of the suction head. In this regard, the Applicant has observed that, for cleaning effectiveness, it is particularly advantageous not only to perform suction of the powder from the surfaces but also to lift said powder by means of compressed air jets. The coffee powder used in such capsule packaging plants, regardless of the coffee grinding degree, always contains a fraction with an extremely fine particle size (commonly referred to as “impalpable”), which is particularly adhesive to the surfaces of the production machines, making it difficult to remove by suction alone. On the contrary, the method and the machine according to the present invention, thanks to the combined action of compressed air and suction, allow achieving a high degree of cleanliness.

The present invention, in one or more of the aforementioned aspects, may comprise one or more of the following preferred features.

Preferably said suction head comprises a suction mouth.

Preferably said suction mouth lies on a resting plane.

Preferably said housing body comprises a face containing said inlet of said seat.

Preferably said face lies on a respective resting plane, more preferably arranged horizontally at least when said housing body is in said first configuration.

Preferably realizing said reciprocal operational configuration comprises arranging said resting plane of said suction mouth of said suction head parallel to said respective resting plane of said face of said housing body containing said inlet of said seat. Preferably, said resting plane of said suction mouth is arranged parallel to said respective resting plane of said face of said housing body containing said inlet of said seat at least when said cleaning system and said coupling unit are in said reciprocal operational configuration. In this way, the cleaning is effective.

Preferably at least in said reciprocal operational configuration, said resting plane of said suction mouth and said respective resting plane of said face of the housing body are arranged horizontally.

Preferably realizing said reciprocal operational configuration comprises arranging said suction mouth, and preferably also said at least emission mouth, above said inlet of said seat. Preferably, said suction mouth, and preferably also said at least one emission mouth, are arranged above said inlet of said seat at least when said cleaning system and said coupling unit are in said reciprocal operational configuration.

Preferably said machine for coupling is a rotational machine configured for performing (at least) a respective process for coupling said component to said article by each coupling unit. In other words, the machine performs (at least) a respective process for coupling a component to an article for each coupling unit installed on board the machine.

Preferably said method for cleaning is performed on said coupling unit while said coupling machine performs a respective process for coupling by said further coupling unit. In this way, it is not necessary to stop the machine, and therefore the production, to perform the cleaning.

Preferably said process for coupling comprises moving said coupling unit along a trajectory, preferably circular around a rotation axis. Typically, the rotation axis passes externally to the coupling unit. For example, the machine for coupling comprises a carousel to which all the coupling units are fixed to rotate around the common rotation axis.

Preferably realizing said reciprocal operational configuration comprises maintaining said cleaning system in a fixed position, corresponding to a predetermined angular position of said coupling unit along said circular trajectory, and moving said coupling unit along said circular trajectory.

Preferably said machine comprises a fixed frame.

Preferably said driving system is connected (more preferably, only) to said coupling unit to move said coupling unit relative to said frame along a trajectory, preferably circular around a rotation axis.

Preferably said driving system comprises, more preferably consists of, a rotation system for said coupling unit being part of said rotational machine for coupling.

Preferably said cleaning system is rigidly fixed to said frame in a fixed position corresponding to a predetermined angular position of said coupling unit along said circular trajectory.

In this way, the method and the machine are further simplified and rational, as, for example, no additional moving parts for the cleaning system are provided beyond the unit, but instead, the movement of the coupling unit along the already predetermined circular trajectory for the process for coupling is used for cleaning the coupling unit.

Preferably activating said suction head is performed at least partially simultaneously with said activating said at least one emission mouth. In this way, the cleaning effectiveness is further improved.

Preferably activating said suction head is performed at least partially simultaneously with said realizing said reciprocal operational configuration. In this way, the method is highly rational and efficient.

In a preferred embodiment, activating said suction head is performed simultaneously with said realizing said activating said at least one emission mouth, more preferably for the same time interval as said activating of said at least one emission mouth of compressed air connected to a compressed air circuit. In this way, suction is ensured whenever compressed air is emitted for dust lifting. This further encourages the effectiveness of cleaning.

Preferably said suction head comprises a suction hood.

Preferably providing said cleaning system comprises providing said suction hood being part of said suction head.

Preferably said at least one emission mouth is arranged inside a suction volume defined by said suction hood. In this way, the cleaning efficiency is increased, as the coffee dust lifted by the compressed air is confined within the hood, improving the suction (e.g., with the same suction power) and limiting further dispersion of the coffee dust into the air.

Preferably said cleaning system comprises a further suction head (distinct and separate from said suction head). Preferably said further suction head is arranged adjacent to said suction head. Preferably said further suction head is arranged downstream of said suction head relative to a direction of motion of said coupling unit along said circular trajectory.

Preferably said further suction head comprises a respective suction mouth.

Preferably, the method comprises, with said housing body in said first configuration, more preferably after said realizing said reciprocal operational configuration, realizing a further reciprocal operational configuration between said cleaning system and said coupling unit in which said further suction head is in mutual proximity with said housing body and at said inlet of said seat. Preferably, said driving system is configured to realize, with said housing body in said first configuration, a further reciprocal operational configuration between said cleaning system and said coupling unit in which said further suction head is in mutual proximity with said housing body and at said inlet of said seat. In this way, the overall cleaning efficiency is further improved.

Preferably realizing said further reciprocal operational configuration comprises one or more, more preferably all, of the characteristics of said realizing said reciprocal operational configuration (referred, where appropriate, to the further suction head and relative suction mouth). In this way, the cleaning process is rational and efficient. Preferably said method comprises activating said further suction head, more preferably at least partially simultaneously with said realizing said further reciprocal operational configuration. In this way, energy consumption is reduced.

It is specified that some steps of the above-described method may be independent of the execution order reported, except where a sequential or simultaneous execution of two or more steps is expressly indicated. Additionally, some steps may be optional. Furthermore, some steps may be performed repetitively or may be executed in series or in parallel with other steps of the method.

### BRIEF DESCRIPTION OF THE FIGURES

FIG. 1 shows a schematic plan view of a production plant for infusion capsules;

FIG. 2 schematically shows a partial view of a detail of a machine for coupling according to the present invention;

FIG. 3 schematically shows a further partial view of the machine for coupling according to the present invention; and

FIG. 4 shows schematically shows a further partial view of the machine for coupling according to the present invention.

### DETAILED DESCRIPTION OF SOME EMBODIMENTS OF THE INVENTION

The features and advantages of the present invention will be further clarified by the following detailed description of some embodiments, provided by way of example and not limitation, with reference to the attached figures.

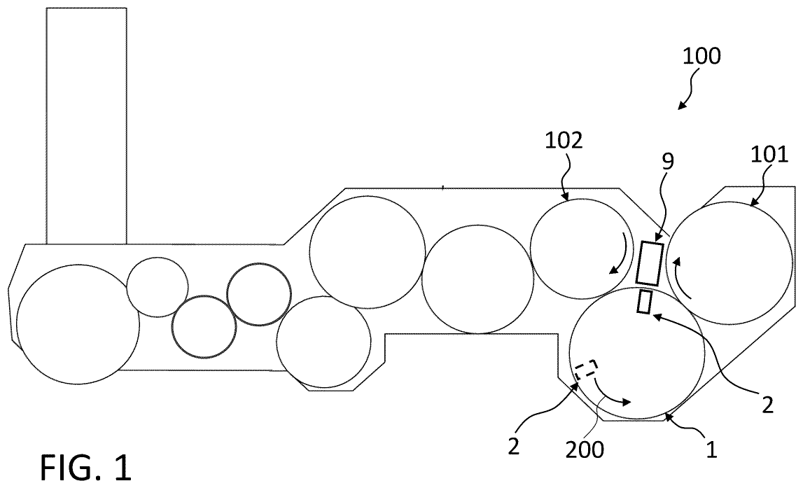

In FIG. 1, an exemplary production plant 100 for infusion capsules is shown (not displayed, as they are, for example, of a known type), such as capsules containing coffee powder.

Exemplarily, the plant comprises a plurality of rotational machines (very schematically shown in FIG. 1, each represented by a respective circle) designed to perform one or more actions in the production process of infusion capsules, such as filter forming, capsule body filling, sealing, quality control, etc., for example, of a known type.

Still referring to FIG. 1, the number 1 globally indicates a machine for coupling a component to an article (not shown) within the plant 100.

Exemplarily the article consists of a capsule body of a capsule containing coffee powder, while the component consists of a thermosalable lid for the capsule body. The coupling performed by the machine 1 therefore coincides, within the capsule production process, with the sealing, typically in a protective atmosphere, of the capsule bodies using the lid. For example, the capsule body can be made of a multilayer material, such as composite materials comprising overlapping layers made from one or more of the following materials: polypropylene (PP), EVOH (Ethylene Vinyl Alcohol), polyethylene terephthalate (PET), polystyrene (PS). In one embodiment, the composite material of the capsule body may include at least one layer of metallic material or metal alloy, such as aluminum or aluminum alloy. For example, the lid comprises a laminated material, including at least one layer of aluminum.

The capsules will not be further described as they are, for example, of known type.

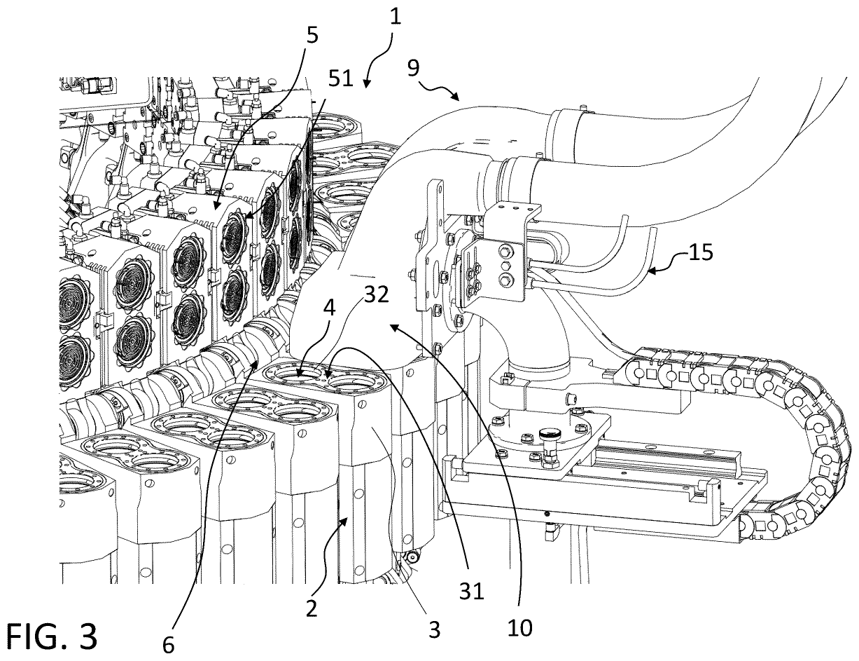

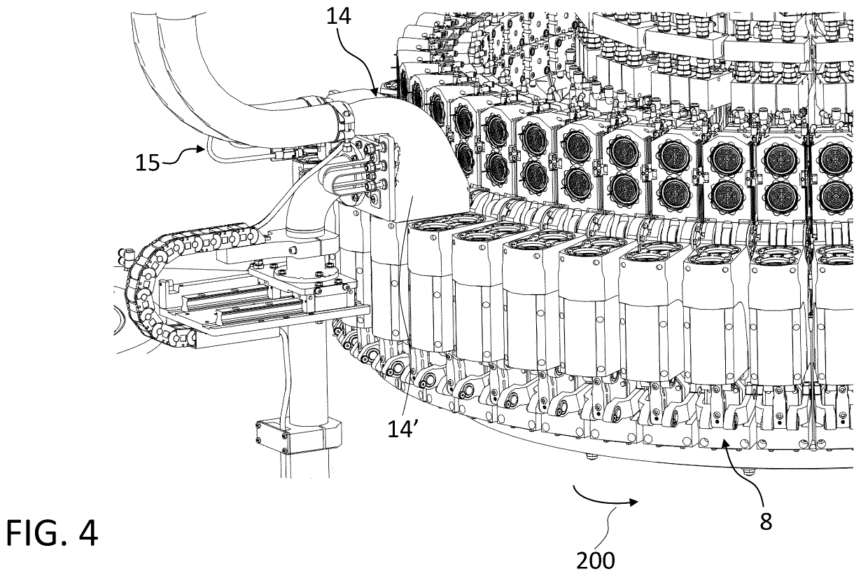

Exemplarily the machine 1 comprises a plurality of coupling units 2, shown in more detail in FIGS. 3 and 4.

Exemplarily the machine 1 is a rotational machine comprising a fixed frame (not shown).

Exemplarily the machine 1 also comprises a driving system (not shown) connected to each coupling unit 2 and configured to move each coupling unit 2 relative to the frame along a trajectory, preferably circular around a common axis of rotation (exemplarily vertical). More specifically, the driving system comprises at least one movable frame 8 to which each coupling unit 2 is fixed. Machines of this type are generally known and will not be further described here. For example, insofar as compatible with the present description, the machine for coupling 1 and each coupling unit 2 can be of the type described in the document WO2022029546A1, cited above.

Exemplarily each coupling unit 2 comprises a respective housing body 3 comprising at least one seat 4 shaped for accommodating the article. Specifically, each housing body 3 comprises a pair of seats 4, each seat being shaped for accommodating a respective capsule body.

Exemplarily each housing body 3 comprises a face 31 containing an inlet 32 of each seat 4. Exemplarily the face 31 lies on a respective resting plane, which is always horizontal for any position and/or configuration of the housing body 3. In fact, each coupling unit 2 rotates around the axis of rotation while maintaining the face 31 of its respective housing body 3 always positioned horizontally.

Exemplarily, each coupling unit 2 also comprises a respective coupling device 5 configured for retaining the component (e.g., lid). In detail, each coupling device 5 comprises a pair of holding elements 51 configured to retain a respective component, for example, by means of a suction system (not shown).

Exemplarily each coupling unit 2 comprises a handling system 6 configured for reciprocally moving the respective housing body 3 and the respective coupling device 5 between a first configuration (shown in FIGS. 3 and 4), in which the respective housing body 3 and the respective coupling device 5 are mutually spaced apart, and a second configuration (not shown), in which the respective housing body 3 and the respective coupling device 5 are positioned closely to each other for allowing a coupling between the component and the article.

Exemplarily the handling system 6 is structured for moving only the coupling device 5 of each coupling unit 2 alternately towards and away (with motion having a vertical component) from the respective housing body 3, while keeping the housing body 3 in a fixed position.

It is specified that, for simplicity of representation, in FIGS. 3 and 4, the housing bodies and coupling devices of all the coupling units 2 of machine 1 are arranged in their respective first configurations, that is, mutually spaced apart. In a real machine, however, there are typically some coupling units that have their respective housing body and respective coupling device in the first configuration, while other coupling units have (typically simultaneously) their respective housing body and respective coupling device in the second configuration. The transition from the first to the second configuration typically occurs during the movement of the coupling unit along the aforementioned circular trajectory.

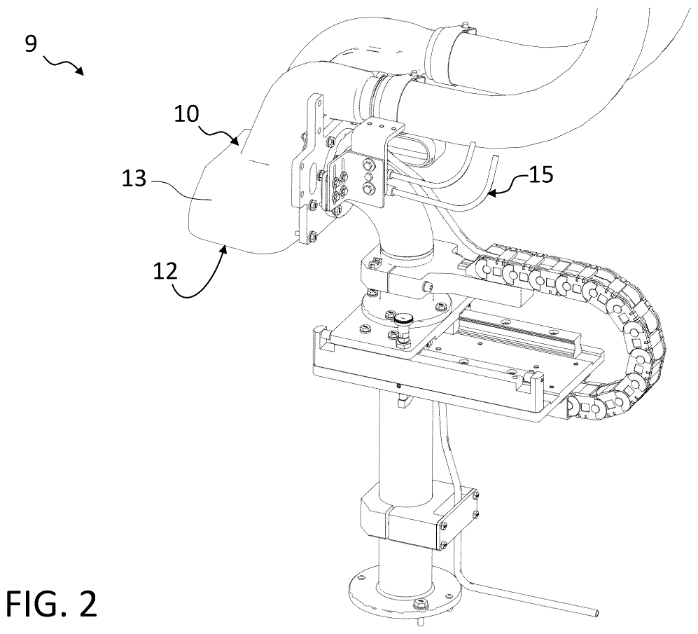

Exemplarily the machine 1 further comprises a cleaning system 9, shown alone in FIG. 2 and inside machine 1 in FIGS. 3 and 4.

Exemplarily the cleaning system 9 is rigidly fixed to the fixed frame of the machine in a fixed position corresponding to a predetermined angular position of the coupling unit 2 along the circular trajectory.

Exemplarily the cleaning system 9 comprises a suction head 10 and at least one emission mouth (of a known type and not visible in the figures) connected to a compressed air circuit 15. Optionally, multiple emission mouth connected to the compressed air circuit 15 may be provided, each emitting a respective jet of compressed air.

Exemplarily the suction head 10 comprises a suction mouth 12 lying on a resting plane (not visible).

Exemplarily the suction head 10 further comprises a suction hood 13, the suction mouth 12 forming at least partially one face of the suction hood 13 facing the coupling unit 2 in at least one operational configuration (further described below).

The emission mouth is exemplarily arranged inside a suction volume defined by the suction hood 13.

Exemplarily the cleaning system 9 comprises a further suction head 14 arranged adjacent to the suction head 10, downstream of the suction head 10 relative to a direction of motion 200 (exemplarily counterclockwise) of the coupling unit 2 along the circular trajectory.

Exemplarily the further suction head 14 comprises a respective suction inlet lying on a respective resting plane (not visible) and a respective suction hood 14′ with a face at least partially formed by the respective suction mouth.

Exemplarily the machine 1 is configured to perform a respective process for coupling of a component to an article via each coupling unit 2. The process for coupling can, for example, be the one described in the aforementioned document WO2022029546A1, as far as compatible here. For the purposes of the present invention, only some key stages of the process for coupling will be described.

In particular, the process for coupling exemplarily comprises moving each coupling unit 2 along the circular trajectory, exemplarily in the aforementioned direction of movement.

During the movement along this circular trajectory, each coupling unit 2 receives, for each seat 4 of the housing body 3, a respective article, which is housed in the seat 4.

Simultaneously, the coupling device 5 receives a respective component for each article housed in the seats 4.

During the movement along the circular trajectory of the respective coupling unit 2, the coupling device 5 is exemplarily lowered towards the housing body 3 so that the second configuration is assumed and the reciprocal coupling between the component and the article takes place. Subsequently, the coupling device 5 is raised from the housing body, opening the seats 4 and exemplarily allowing the extraction of the article coupled to the component from the respective seat.

Simultaneously with the extraction of the article coupled to the component, the housing body 3 and the coupling device 5 typically (again) assume the first configuration (in order to receive a new article and a new component to be coupled together). During this time interval, exemplarily corresponding to the portion of angular positions assumed by the coupling unit 2 in the circular trajectory segment between the station following the machine 1 and the previous station (each represented in FIG. 1 by a respective further rotary machine 101, 102), the cleaning method for the coupling unit 2 is exemplarily executed as described below for an exemplary embodiment and with specific reference to a single coupling unit 2.

Exemplarily the method is performed on each coupling unit, as each coupling unit 2 passes in front of the cleaning system 9 during its motion along the circular trajectory driven by the drive system.

Exemplarily the method therefore comprises providing the machine 1 as described above. Exemplarily the method comprises, with the housing body 3 in the first configuration, realizing a reciprocal operational configuration between the cleaning system 9 and the coupling unit 2 (a coupling unit 2 passing in front of the cleaning system), in which the suction head 10 and the emission mouth 11 are in mutual proximity with the housing body 3 and at the inlet 32 of the seat 4. More specifically, in the aforementioned reciprocal operational configuration, the suction head 10 and the emission mouth are simultaneously in correspondence with the respective inlets 32 of both seats 4 formed in the housing body 3.

Exemplarily realizing the reciprocal operational configuration comprises maintaining the cleaning system 9 in the fixed position corresponding to the predetermined angular position of the coupling unit 2 along the circular trajectory, and moving the coupling unit 2 along the circular trajectory, as exemplarily described above in relation to the process for coupling. In other words, the cleaning system 9 remains exemplarily in a fixed position, and it is the coupling units 2, moved for the purpose of the coupling process, that sequentially position themselves in front of the cleaning system 9.

Exemplarily realizing the reciprocal operational configuration further comprises positioning the resting plane of the suction mouth 12 of the suction head 10, and exemplarily also the respective resting plane of the suction mouth of the additional suction head 14, parallel to the respective resting plane of the face 31 of the housing body 3 containing the mouth of the seat 4. Exemplarily, this is advantageously achieved by positioning the suction mouths on a fixed resting plane arranged horizontally (since the face 31 always lies horizontally).

Exemplarily realizing the reciprocal operational configuration further comprises positioning the suction mouth 12 of the suction head 10, the emission mouth, and the respective suction mouth of the further suction head 14, above the mouth 32 of the seat 4. Exemplarily this is advantageously achieved by positioning the suction mouths of both suction heads and the emission mouth at a fixed vertical height greater than the fixed vertical height at which the face 31 of the housing body 3 passes when the respective coupling unit 2 moves along the circular trajectory. The vertical height at which the suction mouths and the emission mouth are positioned is exemplarily just slightly greater than the vertical height of the face 31, in such a way as to benefit the cleaning process while limiting the suction and compressed air emission power.

Exemplarily given the arrangement of the face 31 of each housing body 3, the suction mouth 12 and the respective suction mouth of the further suction head 14 are directed downward, as exemplarily shown in FIGS. 3 and 4.

Exemplarily it is therefore envisaged activating the suction head 10 and the emission mouth to suck up coffee powder residues from the face 31 of the housing body 3 and from inside the seat 4.

Exemplarily activating the suction head 10 is performed at least partially simultaneously with activating the emission mouth. Optionally, it may be provided activating the suction head first and then the emission mouth immediately afterward, in such a way as to limit further spreading of coffee powder by the compressed air emitted, quickly sucking up the powder that is lifted.

In one embodiment activating the suction head is performed simultaneously with activating the emission mouth, for the same time interval as the operation of the emission mouth.

Exemplarily the method further comprises, after realizing the reciprocal operational configuration, realizing, with the housing body 3 in the first configuration, a further reciprocal operational configuration between the cleaning system 9 and the coupling unit 2, in which the further suction head 14 is in mutual proximity with the housing body 3 and at the mouth 32 of the seat 4 (e.g., of both seats 4). Advantageously, the further reciprocal operational configuration is also created by keeping the cleaning system 9 stationary and moving the coupling unit 2 along the circular trajectory. In the further reciprocal operational configuration, the suction mouth of the further suction head 14 is disposed above the inlet of the seat, with the respective resting plane arranged parallel to the resting plane of the first face.

Exemplarily, the method further comprises activating the further suction head 14 at least partially simultaneously with realizing the further reciprocal operational configuration.

1. A method for cleaning a coupling unit for coupling a component to an article, said method comprising the steps of:
providing said coupling unit comprising:
a housing body comprising at least one seat shaped for accommodating said article,
a coupling device configured for retaining said component,
a handling system configured for reciprocally moving said housing body and said coupling device between a first configuration, in which said housing body and said coupling device are mutually spaced apart, and a second configuration, in which said housing body and said coupling device are positioned closely to each other for allowing a coupling between said component and said article;
providing a cleaning system comprising a suction head and at least one emission mouth for emitting pressurized air connected to a compressed air circuit;
with said housing body in said first configuration, realizing a reciprocal operational configuration between said cleaning system and said coupling unit in which said suction head and said at least one emission mouth are in mutual proximity with said housing body and at an inlet of said seat;
activating said suction head;
activating said at least one emission mouth.

2. The method according to claim 1, wherein realizing said reciprocal operational configuration comprises arranging a resting plane of a suction mouth of said suction head parallel to a resting plane of a face of said housing body containing said inlet of said seat.

3. The method according to claim 1, wherein realizing said reciprocal operational configuration comprises arranging a suction mouth of said suction head and said at least one emission mouth above said inlet of said seat.

4. The method according to claim 1, comprising providing a coupling machine comprising said coupling unit and at least one further coupling unit, wherein said coupling machine is a rotational machine configured to perform a respective process for coupling a component to an article by each coupling unit, and wherein said method for cleaning is performed on said coupling unit while said coupling machine performs a respective process for coupling by said further coupling unit.

5. The method according to claim 4, wherein said process for coupling comprises moving said coupling unit along a trajectory, preferably circular around a rotation axis, and wherein realizing said reciprocal operational configuration comprises maintaining said cleaning system in a fixed position, corresponding to a predetermined angular position of said coupling unit along said circular trajectory, and moving said coupling unit along said circular trajectory.

6. The method according to claim 1, wherein said activating said suction head is performed at least partially simultaneously with said activating said at least one emission mouth.

7. The method according to claim 1, wherein providing said cleaning system comprises providing a suction hood being part of said suction head, and wherein said at least one emission mouth is arranged inside a suction volume defined by said suction hood.

8. A machine for coupling a component to an article, wherein said machine comprises:
at least one coupling unit comprising:
a housing body comprising at least one seat shaped for accommodating said article,
a coupling device configured for retaining said component,
a handling system configured for reciprocally moving said housing body and said coupling device between a first configuration, in which said housing body and said coupling device are mutually spaced apart, and a second configuration, in which said housing body and said coupling device are positioned closely to each other for allowing a coupling between said component and said article;
a cleaning system comprising a suction head and at least one emission mouth for emitting pressurized air connected to a compressed air circuit;
a driving system connected to at least one among said coupling unit and said cleaning system and configured for realizing, with said housing body in said first configuration, a reciprocal operational configuration between said cleaning system and said coupling unit in which said suction head and said at least one emission mouth are in mutual proximity with said housing body and at an inlet of said seat.

9. The machine according to claim 8, wherein said suction head comprises a suction mouth lying on a resting plane arranged parallelly to a resting plane of a face of said housing body containing said inlet of said seat at least when said cleaning system and said coupling unit are in said reciprocal operational configuration.

10. The machine according to claim 8, wherein said suction head comprises a suction mouth, and wherein said suction mouth and said at least one emission mouth are arranged above said inlet of said seat at least when said cleaning system and said coupling unit are in said reciprocal operational configuration.

11. The machine according to claim 8, wherein said suction head comprises a suction hood, and wherein said at least one emission mouth is arranged inside a suction volume defined by said suction hood.

12. The machine according to claim 8, wherein said machine is a rotational machine configured for performing a process for coupling said component to said article, wherein said machine comprises a fixed frame, wherein said driving system is connected to said coupling unit to rotate said coupling unit relative to said frame along a trajectory, preferably circular around a rotation axis, and wherein said cleaning system is rigidly fixed to said frame in a fixed position corresponding to a predetermined angular position of said coupling unit along said circular trajectory.

13. The machine according to claim 12, wherein said cleaning system comprises a further suction head arranged adjacent to said suction head, wherein said further suction head is arranged downstream of said suction head relative to a direction of motion of said coupling unit along said circular trajectory.
